(19) United States
(12) Patent Application Publication
(10) Pub. No.: US 2012/0054051 A1
(43) Pub. Date: Mar. 1, 2012

(54) INFORMATION PROCESSING APPARATUS AND COMPUTER PROGRAM PRODUCT

(75) Inventor: Masato Hirono, Shizuoka (JP)

(73) Assignee: TOSHIBA TEC KABUSHIKI KAISHA, Tokyo (JP)

(21) Appl. No.: 13/215,453

(22) Filed: Aug. 23, 2011

(30) Foreign Application Priority Data
Aug. 24, 2010 (JP) 2010-187521

(51) Int. Cl. G06Q 20/20

(52) U.S. Cl. 705/23; 705/16

(57) ABSTRACT

According to an embodiment, an input unit, a notification unit, a receiving unit, and a registration unit are provided. The input unit inputs commodity information representing a commodity to be registered. The notification unit notifies of the fact that it is possible to input the number of commodities, which are represented by the input commodity information, to be registered in same transaction processing if the commodity represented by the input commodity information is the same as a commodity which was already registered in the same transaction processing. The receiving unit receives the input of the number of commodities, which are represented by the input commodity information, to be registered in the same transaction processing. The registration unit registers the input number of commodities represented by the input commodity information.

### CROSS-REFERENCE TO RELATED APPLICATION

This application is based upon and claims the benefit of priority from: Japanese Patent Application No. 2010-187521, filed on Aug. 24, 2010, the entire contents of which are incorporated herein by reference.

### FIELD

The exemplary embodiments described herein relate to an information processing apparatus and a computer program product.

### BACKGROUND

A self-checkout terminal is a terminal which is used by a customer to perform a registration operation and a checkout operation for a commodity to be purchased. The self-checkout terminal is equipped with a weight check function by a weighing apparatus after reading a barcode or the like by a scanner in order to prevent customer impropriety. In addition, the self-checkout terminal is equipped with a multiplication function by which it is possible to omit reading of the barcodes by a scanner for a plurality of the same commodities by receiving input of the number of the same commodities through a keyboard and registering the input number of the commodities.

However, there is a problem in that a customer who is not used to using the self-checkout terminal does not know that it is possible to register the same kind of commodities at once by inputting the number of the same kind of commodities and performs the commodity registration operation for each commodity when the customer registers a plurality of the same commodities and in that inconvenience of the commodity registration operation is not yet solved.

### DESCRIPTION OF THE DRAWINGS

FIG. 1 is a diagram schematically showing an overall system configuration.

FIG. 2 is a perspective view showing a self-checkout terminal.

FIG. 3 is a diagram showing various keys arranged on an LCD screen.

FIG. 4 is a perspective view showing a state in which a shopping bag is held by a holding arm.

FIG. 5 is a block diagram showing an electrical hardware configuration of a settlement terminal.

FIG. 6 is a diagram showing an example of a commodity master file.

FIG. 7 is a flowchart showing a flow of commodity information registration processing in a self-checkout terminal according to an embodiment.

FIG. 8 is a diagram showing an example of a message displayed on an LCD.

FIG. 9 is a diagram showing an example of a message displayed on an LCD.

FIG. 10 is a flowchart showing a flow of commodity registration processing in a self-checkout terminal according to an embodiment.

FIG. 11 is a flowchart showing a flow of commodity registration processing in a self-checkout terminal according to an embodiment.

FIG. 12 is a flowchart showing a flow of commodity registration processing in a self-checkout terminal according to an embodiment.

### DETAILED DESCRIPTION

According to an embodiment, an input unit, a notification unit, a receiving unit, and a registration unit are provided. The input unit is for inputting commodity information representing a commodity to be registered. The notification unit is for notifying that it is possible to input the number of the commodities represented by the input commodity information, which are registered in the same transaction processing, when the commodity represented by the input commodity information is the same commodity as that which was already registered in the same transaction processing. The receiving unit is for receiving the input of the number of the commodities represented by the input commodity information, which are registered in the same transaction processing. The registration unit is for registering the input number of the commodities represented by the input commodity information.

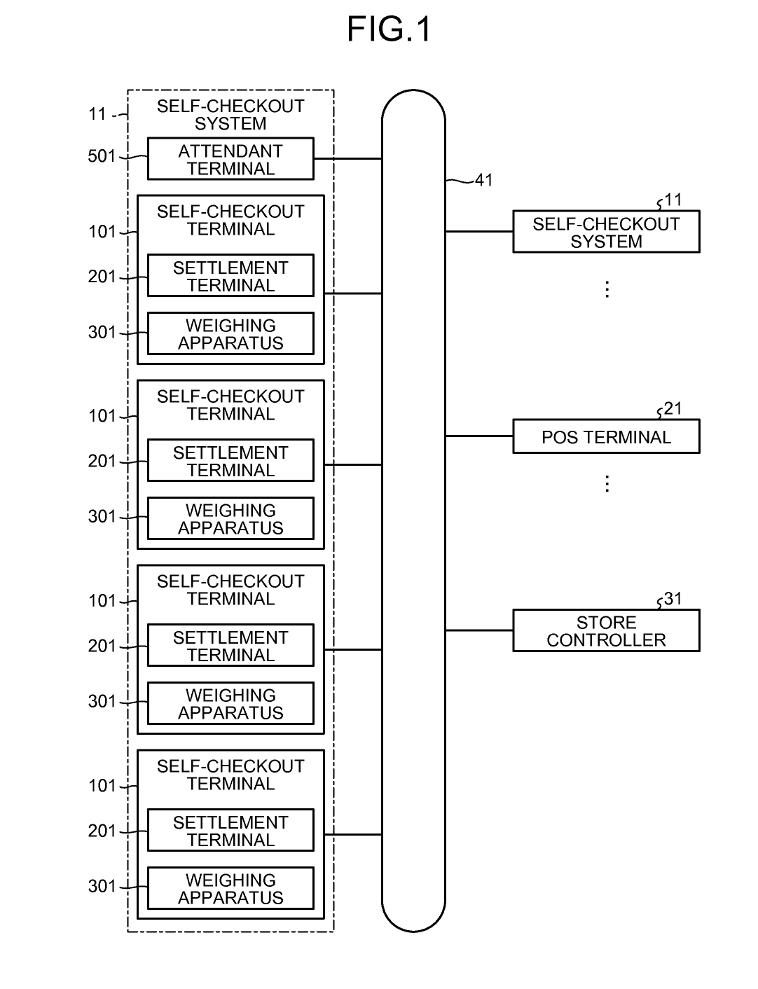

FIG. 1 is a diagram schematically showing an overall system configuration. The system according to the embodiment is constructed by connecting a plurality of self-checkout systems 11, a plurality of POS (Point Of Sale) terminals 21, and a store controller 31 via a communication network 41. For the self-checkout systems 11, one attendant terminal 501 is allotted to a plurality of self-checkout terminals 101. The self-checkout terminal 101 is a terminal which reads commodity information from a barcode attached to a commodity to be purchased by a customer and performs registration and the like of the commodity represented by the read commodity information.

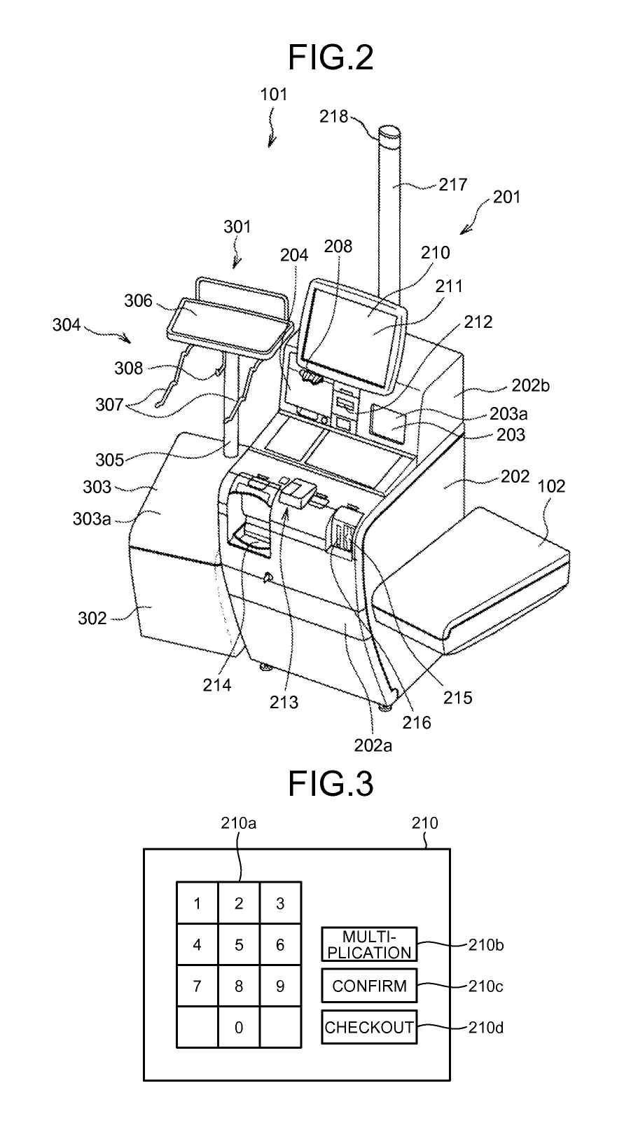

FIG. 2 is a perspective view showing the self-checkout terminal. The self-checkout terminal 101 is provided with a settlement terminal 201 and a weighing apparatus 301.

The settlement terminal 201 includes a housing 202 with a shopping basket placing table 102, on which a basket (not shown) containing the commodity to be registered is placed, protruding from the side thereof.

The housing 202 of the settlement terminal 201 includes a base housing 202a which is installed on the floor surface and an upper housing 202b which is placed on the upper surface of the base housing 202a. The front surface of the base housing 202a is inclined such that the projection area of the base housing 202a becomes smaller in the lower part. With such a configuration, the base housing 202a has a shape which is offset on the further side in the lower part.

In the settlement terminal 201, a barcode scanner 203 is arranged on the side of the shopping basket placing table 102 of the upper housing 202b. Moreover, a printer cover 204 is arranged on the opposite side to the side of the shopping basket placing table 102 of the upper housing 202b in the settlement terminal 201. Furthermore, a card insertion port 212 is arranged between the barcode scanner 203 and the printer cover 204 in the settlement terminal 201.

The barcode scanner 203 includes a reading surface 203a formed with a glass plate. The barcode scanner 203 is a vertical scanner which irradiates a reading space positioned in front of the reading surface 203a with a predetermined laser beam pattern. According to the barcode scanner 203, reflection light from the barcode is received by a light receiving element (not shown) if the barcodes attached to the commodity positioned in the reading space is made to face the reading surface 203a. Then, the barcode scanner 203 is an input unit which decodes a light receiving signal of the barcode based on an output signal of the light receiving element, obtains commodity information such as a commodity name, a commodity code, and the like represented by the decoded barcode as code data, and inputs the code data to the control unit 253 of the settlement terminal 201 (see FIG. 5).

The printer cover 204 includes a receipt issuing port 208. The settlement terminal 201 installs a receipt printer 251 (see FIG. 5) on the further side than the printer cover 204. The settlement terminal 201 issues a receipt, which is not shown in the drawing, printed by the receipt printer 251 from the receipt issuing port 208. In addition, the printer cover 204 is attached to the upper housing 202b so as to be freely opened and closed, in the settlement terminal 201.

The settlement terminal 201 installs a card reader writer 252 (see FIG. 5), which is a magnetic card reader writer for reading and writing data from and on a magnetic card, in the card insertion port 212. The customer who uses the self-checkout terminal 101 may insert a credit card as a magnetic card into the card insertion port 212.

The settlement terminal 201 includes an LCD (Liquid Crystal Display) 210 as a display unit, which displays commodity information such as a commodity name, a price, an image, and the like of the registered commodity for the shopper, in the upper housing 202b. In the settlement terminal 201, a touch panel 211 with various keys for inputting commodity information of a commodity which cannot be registered with a code symbol, the number of the same commodities (the same kind of commodities to which the same barcodes are attached), and the like arranged thereon is laminated on the screen of the LCD 210. FIG. 3 is a diagram showing the various keys arranged on the screen of the LCD. As shown in FIG. 3, a multiplication button 210b for requesting registration of the same commodities, a numerical keypad 210a which is for inputting the number of same commodities, a confirm key 210c for the input number of the same commodities, a checkout button 210d which is for requesting commodity checkout, and the like are arranged on the screen of the LCD 210 in the settlement terminal 201 according to the embodiment.

The settlement terminal 201 installs an money insertion and discharging apparatus 221 (see FIG. 5) for coins and notes in the base housing 202a. A coin inlet port 213 is arranged at the center on the upper surface of the base housing 202a and a coin outlet port 214 is arranged on the left side of the coin inlet port 213 as a part of the money insertion and discharging apparatus 221 in the settlement terminal 201. In addition, a note inlet port 215 and a note output port 216 are arranged on the right side of the coin inlet port 213 in the settlement terminal 201. The money insertion and discharging apparatus 221 includes a mechanism unit which deals with coins and notes and a control unit which controls the mechanism unit (both of which are not shown in the drawing). Since the structure of the mechanism unit which deals with coins and notes and the processing procedure and the like of the control unit which controls the mechanism unit are already known, the description thereof will be omitted.

Furthermore, a display pole 217 as an alarm apparatus which displays a current state of the self-checkout terminal 101 is provided so as to stand on the rear surface of the base housing 202a in the settlement terminal 201. The display pole 217 includes a light emitting unit 218, which selectively emits blue and red light, at the tip end portion.

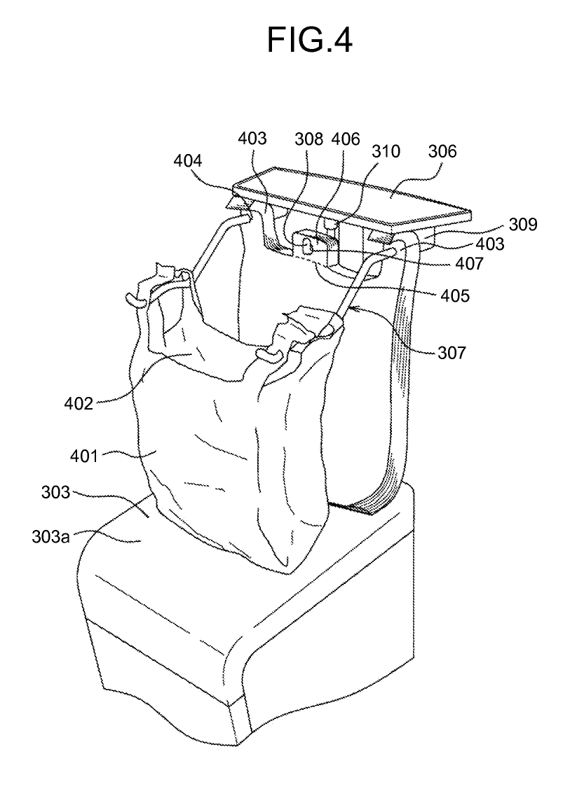

Next, description will be made of the weighing apparatus 301 with reference to FIGS. 2 and 4. FIG. 4 is a perspective view showing a state in which a shopping bag is held by a holding arm. In the weighing apparatus 301, a weighting dish 303 is provided on the upper portion of a weighting housing 302. In the weighing apparatus 301, a bag holding tool 304 holding a shopping bag 401 as a containing member which contains a commodity whose commodity information was input is attached to the weighting dish 303. The weighing apparatus 301 is a measuring unit which measures the load of the commodity contained in the shopping bag 401 and placed on the weighting dish 303. The weighting dish 303 includes a placement table 303a on its upper surface. The weighing apparatus 301 is provided with a bag holding tool 304 attached to the placement table 303a. Therefore, the weighting dish 303 is a table for the bag holding tool 304. Moreover, a pole-shaped arm supporting unit 305 is provided in the weighing apparatus 301 so as to stand at the rear center of the placement table 303a. In addition, a temporary placement table 306 on which a commodity is placed is fixed to the upper end of the arm supporting unit 305 in the weighing apparatus 301. The temporary placement table 306 is a table with a flat upper surface, which is used for the purpose of temporarily placing a commodity whose code symbol was scanned by the barcode scanner 203 of the settlement terminal 201. Both the placement table 303a and the temporary placement table 306 play a role as placement units on which a commodity whose commodity code was input is placed.

In addition, a pair of holding arms 307 and a hook 308 are attached to the lower surface of the temporary placement table 306 in the weighing apparatus 301. That is, arm attachment tools 309 (see FIG. 4) are fixed to both end positions of the lower surface of the temporary placement table 306 in the weighing apparatus 301. Specifically, the arm attachment tools 309 are fixed to both end positions of the lower surface of the temporary placement table 306 via one of various fixation methods such as fixation with screws, fixation with adhesive, and the like in the weighing apparatus 301. In addition, a holding arm 307 is embedded in each of the arm attachment tools 309 in the weighing apparatus 301. Moreover, a hook attachment tool 310 (see FIG. 4) is fixed to the center position of the lower surface of the temporary placement table 306 in the weighing apparatus 301. Specifically, the hook attachment tool 310 is fixed to the center position of the lower surface of the temporary placement table 306 by one of various fixation methods such as fixation with a screw, fixation with adhesive, and the like in the weighing apparatus 301. In addition, a hook 308 is embedded in the hook attachment tool 310 in the weighing apparatus 301.

The holding arm 307 holds a pair of handles 403 in a skewered state in order to hold the shopping bag 401, which includes an opening 402 and the pair of handles 403 protruding from the opening 402, which is folded such that the handles 403 are positioned on both sides. In order to hold the handles 403 in a skewered state, the shopping bag 401 includes a slit 404 in each of the handles 403. In addition, the shopping bag 401 includes a pair of selvage portions 406 which are positioned between the pair of handles 403 and can be removed at perforations 405. The selvage portions 406 include hook holes 407. The hook 308 is inserted into the hook hole 407 and holds the shopping bag 401 with the holding arm 307.

FIG. 5 is a block diagram showing an electrical hardware configuration of the settlement terminal. The settlement terminal 201 includes therein a control unit 253 as an information processing unit. The control unit 253 may have a semiconductor chip configuration in which an operation sequence is written, for example, or may have a microcomputer configuration which is operated by causing a RAM (Random Access Memory) 254 or the like to store an operation program. Here, a control unit 253 with a microcomputer configuration will be introduced.

A CPU (Central Processing Unit) 255 is the core of the control unit 253. In the control unit 253, a ROM (Read Only Memory) 256 which stores fixed data in a fixed manner, a RAM (Random. Access Memory) 254 which stores variable data such as commodity information of the commodities, which are registered in the same transaction processing (that is, before the checkout button 210d is pressed), so as to be freely rewritten, a VRAM (Video Random Access Memory) 257 which generates a display image to be displayed on the LCD 210, and an HDD (Hard Disk Drive) 258 are connected to the CPU 255 via a system bus 259.

In the settlement terminal 201, the barcode scanner 203, the LCD 210, the touch panel 211, the card reader writer 252, the receipt printer 251, the light emitting unit 218, and an interface 260 which mediates data communication with money insertion and discharging apparatus 221 are connected to the control unit 253 via the system bus 259. In addition, the control unit 253 controls the barcode scanner 203, the LCD 210, the touch panel 211, the card reader writer 252, the receipt printer 251, the light emitting unit 218, and the interface 260. In the settlement terminal 201, a communication interface 261 is also connected to the control unit 253 via the system bus 259. The communication interface 261 is connected to the communication network 41 and realizes data communication between the attendant terminal 501 and the store controller 31, and the self-checkout terminal 101. In addition, an interface which realizes data communication with the weighing apparatus 301 is also connected to the control unit 253 via the system bus 259 in the settlement terminal 201 though not shown in the drawing.

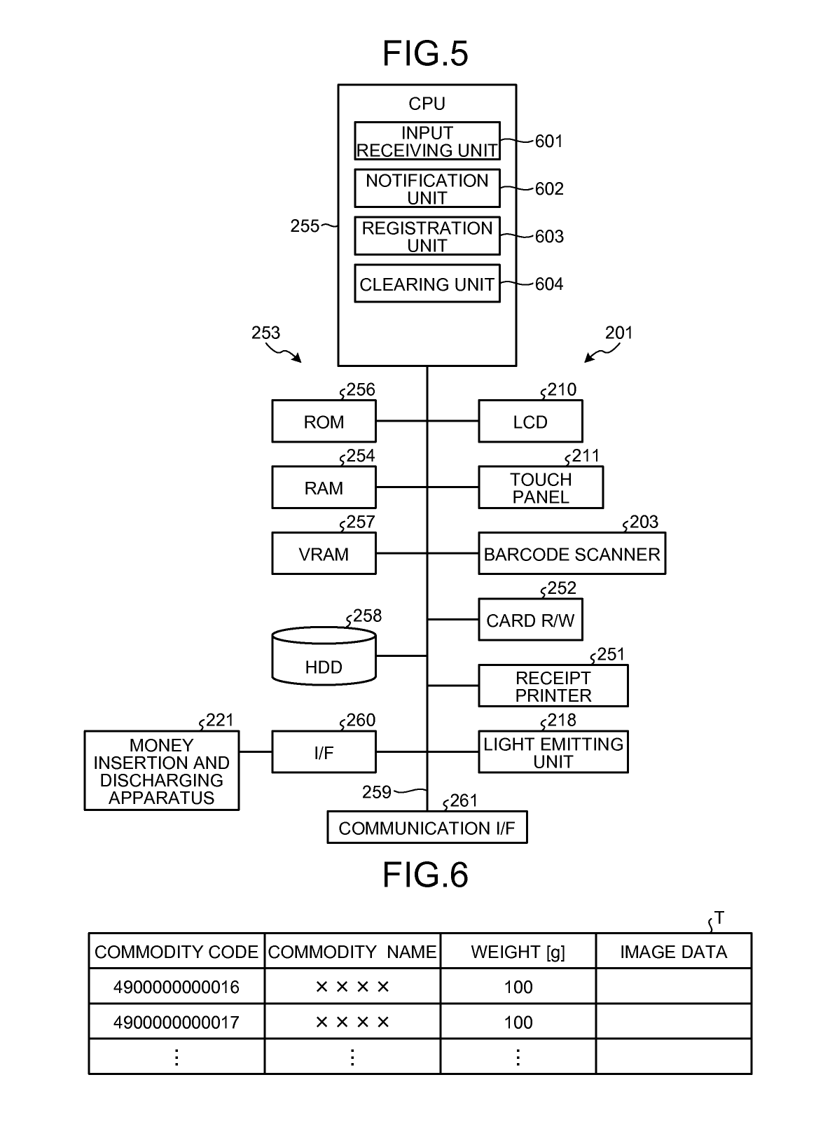

The HDD 258 stores a commodity master file T and takings file which stores sales data and the like as well as the program which causes the control unit 253 to operate. FIG. 6 is a diagram showing an example of the commodity master file. The commodity master file T is for storing a commodity name, a weight of a commodity, an image data of a commodity, and the like corresponding to a commodity code.

Next, description will be made of functions included in the settlement terminal 201 (information processing apparatus) according to the embodiment. The CPU 255 functions as an input receiving unit 601, a notification unit 602, a registration unit 603, and a clearing unit 604 as shown in FIG. 5 by being operated based on a program stored in the HDD 258, which is developed by the RAM 254.

The input receiving unit 601 is for receiving input of the number of same commodities from the numerical keypad 201a when the number of same commodities is input from the numerical keypad 210a through the touch panel 211 and the confirm key 210c is then pressed. In addition, the input receiving unit 601 receives registration request of the same commodities by the multiplication button 210b and the checkout request of the commodities by the checkout button 210d through the touch panel 211.

The notification unit 602 is for determining whether or not a commodity represented by commodity information input by the barcode scanner 203 is the same commodity (that is, the commodity represented by the commodity information stored on the RAM 254) which was already registered in the same transaction processing (that is, before the checkout button 210d was pressed) when the multiplication button 210b was not pressed within a predetermined time period after the input of the commodity information from the barcode scanner 203. Although description will be made of an example in which the barcode scanner 203 inputs commodity information in this embodiment, the same processing can be performed if the customer who operates the self-checkout terminal 101 inputs the commodity information from the touch panel 211.

The notification unit 602 displays a message on the LCD 210 and notifies of the fact that it is possible to input the number of the commodities, which are represented by the commodity information input from the barcode scanner 203, to be registered in the same transaction processing when it was determined that the commodity represented by the commodity information input from the barcode scanner 203 was the same as the commodity represented by the commodity information stored on the RAM 254. Although the notification unit 602 notifies of the fact that the number of the commodities to be registered in the same transaction processing can be input by displaying a message on the LCD 210 in this embodiment, the exemplary embodiments are not limited thereto. For example, the notification unit 602 may notify of the fact that the number of the commodities to be registered in the same transaction processing can be input by causing the light emitting unit 218 to emit light, generating sound from a speaker which is not shown in the drawing, or outputting an message.

In addition, the notification unit 602 displays on the LCD 210 a commodity name input as commodity information from the barcode scanner 203 when the commodity was registered. With such operation, the customer can confirm that the commodity was registered by seeing the commodity name displayed on the LCD 210.

Moreover, the notification unit 602 displays a message on the LCD 210 to prompt the customer to place the commodity again on the weighting dish 303 if the total weight corresponding to the number of the commodities to be registered does not coincide with the weight measured by the weighing apparatus 301.

The registration unit 603 causes the RAM 254 to store the commodity information input from the barcode scanner 203 and registers the commodity represented by the commodity information input from the barcode scanner 203. In this embodiment, the registration unit 603 firstly reads weight corresponding to a commodity code input as commodity information by the barcode scanner 203 from the commodity master file T stored in the HDD 258. Subsequently, the registration unit 603 receives the weight measured by the weighing apparatus 301 when the operator puts the commodity on the weighting dish 303. Then, the registration unit 603 stores the commodity information input from the barcode scanner 203 on the RAM 254 when the read weight coincides with the weight received from the weighing apparatus 301. With such operations, the registration unit 603 registers the commodity represented by the input commodity information.

In addition, the registration unit 603 stores the commodity information input from the barcode scanner 203 corresponding to the input number and registers the input number of the commodities if the input receiving unit 601 receives the input of the number of the commodities to be registered in the same transaction processing. In this embodiment, the registration unit 603 reads weight, which is associated with the commodity code input as commodity information from the barcode scanner 203, from the commodity master file T stored in the HDD 258 if the number to be registered in the same transaction processing is input. Then, the registration unit 603 calculates the weight of the input number of the commodities by multiplying the read weight by the input number. Moreover, the registration unit 603 receives the weight measured by the weighing apparatus 301 if the operator places the input number of the commodities on the weighting dish 303. Then, the registration unit 603 stores the commodity information input from the barcode scanner 203 corresponding to the input number on the RAM 254 if the calculated weight coincides with the weight received from the weighing apparatus 301. With such operations, the registration unit 603 registers the input number of the commodities.

A clearing unit 604 is for clearing the commodity represented by the commodity information stored on the RAM 254 if the input receiving unit 601 receives the commodity checkout request by the checkout button 210d.

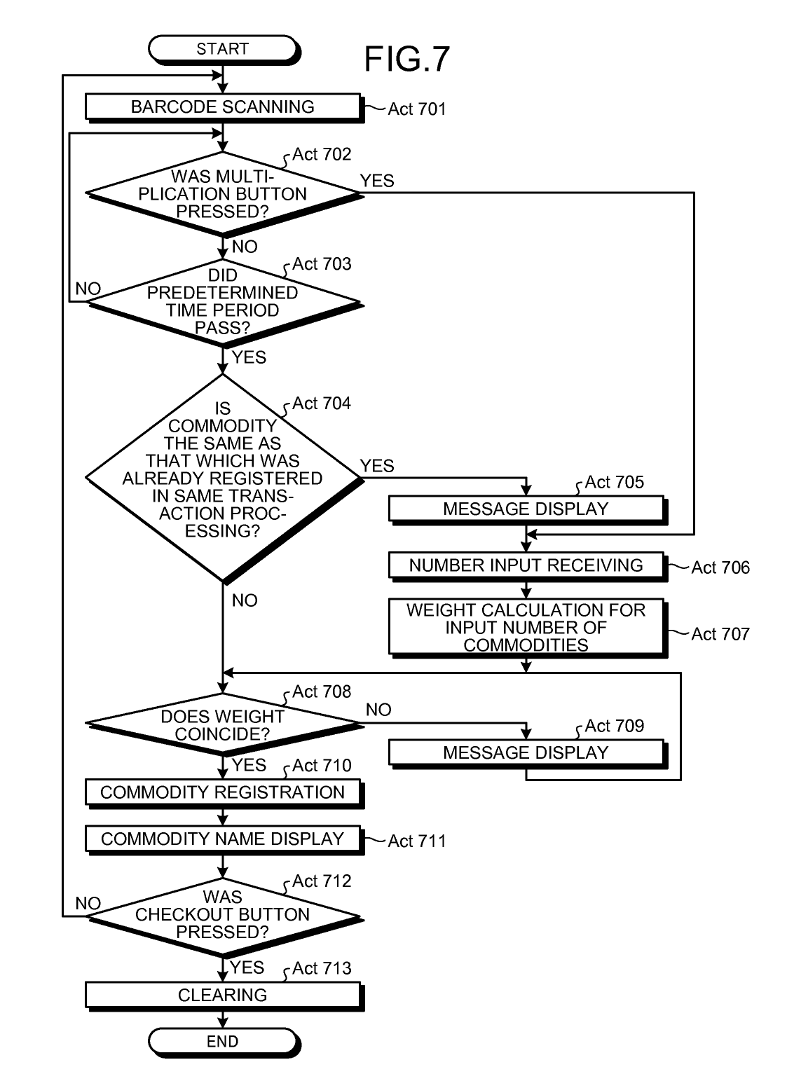

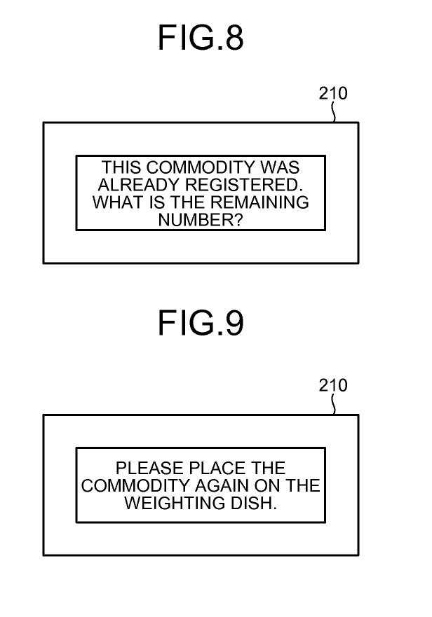

Next, description will be made of a flow of commodity registration processing in the self-checkout terminal 101 according to the embodiment with reference to FIGS. 7 to 9. FIG. 7 is a flowchart showing a flow of commodity registration processing in the self-checkout terminal according to the embodiment. Each of FIGS. 8 and 9 is a diagram showing one example of the message displayed on the LCD.

If barcode scanning is performed by the barcode scanner 203 and the commodity information is input (Act 701), the input receiving unit 601 awaits pressing of the multiplication button 210b (Act 702).

The notification unit 602 determines whether or not a predetermined time period passed without the pressing of the multiplication button 210b after the input of the commodity information from the barcode scanner 203 (Act 703). If the predetermined time passes without the pressing of the multiplication button 210b after the input of the commodity information (Yes: Act 703), the notification unit 602 determines whether or not the commodity represented by the input commodity information is the same as the commodity (commodity represented by the commodity information stored on the RAM 254) which was already registered in the same transaction processing (Act 704). If it is determined that the commodity represented by the input commodity information is the same commodity as that represented by the commodity information which was already registered in the same transaction processing (Yes: Act 704), the notification unit 602 displays a message, which prompts the input of the number of the commodities represented by the input commodity information, on the LCD 210 as shown in FIG. 8 (Act 705). In this embodiment, the notification unit 602 displays a message which prompts the input of the number (remaining number) of the same commodity except for the commodity which was already read by the barcode scanner 203.

In addition, it is determined that the commodity represented by the input commodity information is not the same as the commodity which was already registered in the same transaction processing (No: Act 704), the registration unit 603 determines whether or not the weight associated with the commodity code input as the commodity information from the commodity master file T coincides with the weight of the commodity measured by the weighing apparatus 301 (Act 708). Then, if the weight associated with the input commodity code does not coincide with the weight of the commodity measured by the weighing apparatus 301 (No: Act 708), the notification unit 602 displays on the LCD 210 the message which prompts the customer to place the commodity again on the weighting dish 303 as shown in FIG. 9 (Act 709). On the other hand, if the weight associated with the input commodity code coincides with the measured weight of the commodity (Yes: Act 708), the registration unit 603 stores the input commodity information on the RAM 254. With such operations, the registration unit 603 registers the commodity represented by the input commodity information (Act 710). If the commodity is registered, the notification unit 602 displays the commodity name input as the commodity information on the LCD 210 (Act 711). Thereafter, the notification unit 602 waits for the pressing of the checkout button 210d (Act 712). If the checkout button 210d is pressed and the checkout request is received (Yes: Act 712), the clearing unit 604 clears the commodity represented by the commodity information stored on the RAM 254 (Act 713). On the other hand, if the checkout button 210d is not pressed (No: Act 712) and barcode scanning is newly performed (Act 701), the CPU 255 repeats the aforementioned processing.

In addition, if the multiplication button 210b is pressed within a predetermined time period after the input of the commodity information (Yes: Act 702), or if a message which prompts the input of the number of the commodities represented by the input commodity information is displayed (Act 705), the input receiving unit 601 receives the input of the number of the same commodities to be registered (Act 706). If the multiplication button 210b is pressed, the input receiving unit 601 receives the input of the number of the same commodities including the commodity represented by the commodity information input from the barcode scanner 203. If the message which prompts the input of the number of the commodities represented by the input commodity information is displayed, the input receiving unit 601 receives the input of the number (remaining number) of the same commodity expect for the commodity read by the barcode scanner 203. In addition, if the message which prompts the input of the number of the commodities represented by the input commodity information is displayed, the input receiving unit 601 may receive the input of the number of the same commodities including the commodity represented by the input commodity information.

Subsequently, if the number is input after the multiplication button 210b is pressed within the predetermined time period after the input of the commodity information (Act 706), the registration unit 603 reads the weight associated with the input commodity code from the commodity master file T. Moreover, the registration unit 603 calculates the weight of the input number of the commodities by multiplying the read weight by the input number (Act 707).

Then, the registration unit 603 determines whether or not the calculated weight of the commodities coincides with the weight of the commodities measured by the weighing apparatus 301 (Act 708). Then, if the calculated weight of the commodities does not coincide with the weight of the commodities measured by the weighing apparatus 301 (No: Act 708), the notification unit 602 displays on the LCD 210 the message which prompts the customer to place the commodities again on the weighting dish 303 (Act 709).

On the other hand, if the calculated weight of the commodities coincides with the weight of the commodities measured by the weighing apparatus 301 (Yes: Act 708), the registration unit 603 stores the input commodity information corresponding to the input number of the commodities on the RAM 254 and registers the commodities (Act 710). If the commodities are registered, the notification unit 602 displays on the LCD 210 the commodity name input as the commodity information (Act 711).

In addition, if the number is input after the message which prompts the input of the number of the commodities is displayed (Act 706), the registration unit 603 reads the weight associated with the input commodity code from the commodity master file T. Moreover, the registration unit 603 calculates the weight by multiplying the read weight by a value obtained by adding one to the input number (Act 707). In addition, the registration unit 603 maintains the weight measured by the weighing apparatus 301 immediately before the input of the commodity information from the barcode scanner 203. The weighing apparatus 301 maintains the thus measured weight in order to detect impropriety with the use of the measured weight of the commodities even if the timing at which the multiplication button 302 is pressed deviates from the timing at which the commodity whose commodity information was read is placed on the weighing apparatus 301. In addition, if the number of the same commodities including the commodity represented by the input commodity information is input, the registration unit 603 calculates the weight by multiplying the read weight by the input number.

Then, the registration unit 603 determines whether or not the calculated weight of the commodities coincides with the weight of the commodities measured by the weighing apparatus 301 (Act 708). If the calculated weight of the commodities does not coincide with the weight of the commodities measured by the weighing apparatus 301 (No: Act 708), the notification unit 602 displays on the LCD 210 the message which prompts the customer to place the commodities again on the weighting dish 303 (Act 709).

On the other hand, if the calculated weight of the commodities coincides with the weight of the commodities measured by the weighing apparatus 301 (Yes: Act 708), the registration unit 603 stores the input commodity information corresponding to the number obtained by adding one to the input number of the commodities on the RAM 254 and registers the commodities (Act 710). If the number of the same commodities including the commodity represented by the input commodity information is input, the registration unit 603 stores the input commodity information corresponding to the input number of the commodities on the RAM 254 and registers the commodities. If the commodities are registered, the notification unit 602 displays on the LCD 210 the commodity name input as the commodity information (Act 711).

Thereafter, the input receiving unit 601 awaits the pressing of the checkout button 210d (Act 712). If the checkout button 210d is pressed and the checkout request is received (Yes: Act 712), the clearing unit 604 clears the commodity represented by the commodity information stored on the RAM 254 (Act 713). On the other hand, if the checkout button 210d is not pressed (No: Act 712) and the barcode scanning is newly performed (Act 701), the CPU 255 repeats the aforementioned processing.

According to the self-checkout terminal 101 of this embodiment, it is possible to reduce the inconvenience of the commodity registration operation for a customer who is not used to using the self-checkout terminal since even the customer who is not used to using the self-checkout terminal 101 can also know that a plurality of the same commodities can be registered at once by notifying of the fact that it is possible to input the number of the commodities, which are represented by the input commodity information, to be registered in the same transaction processing if the commodity represented by the input commodity information is the same as the commodity which was already registered in the same transaction processing, receiving input of the input number of the commodities, and registering the input number of the commodities represented by the input commodity information.

In this embodiment, the input number of the commodities represented by the input commodity information may be registered without depending on the weight scaling result of the commodities by the weighing apparatus 301. Hereinafter, the same configurations as those in the aforementioned embodiment will be omitted, and only different configurations from those in the aforementioned embodiment will be described.

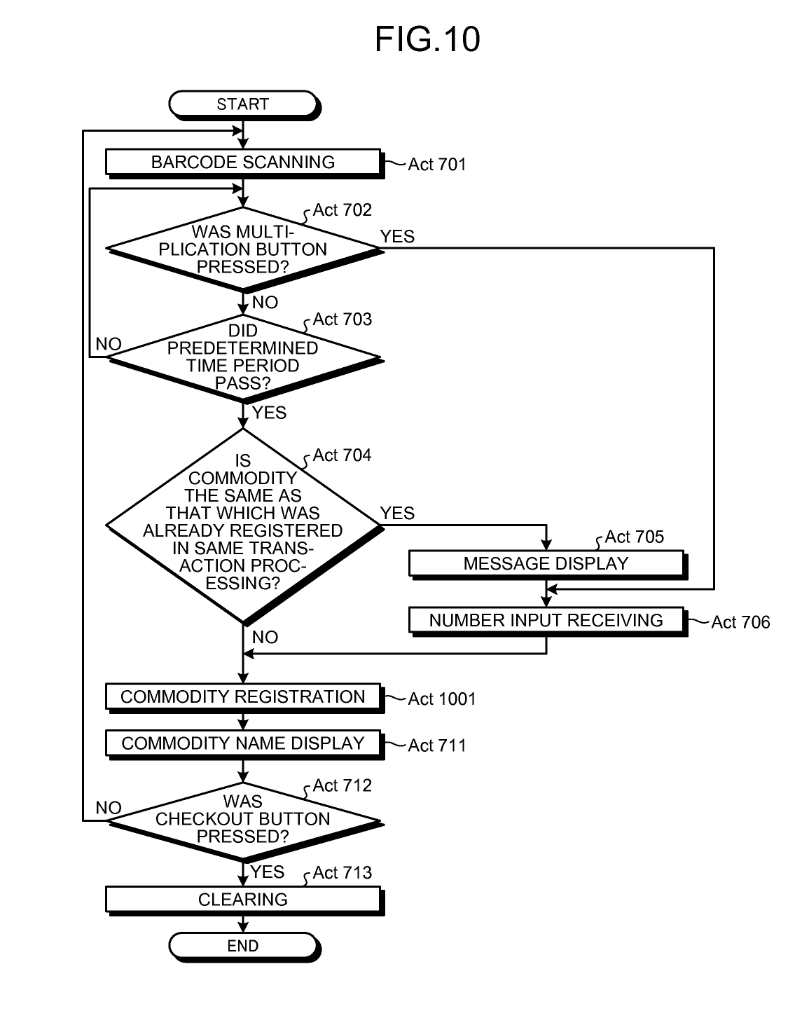

FIG. 10 is a flowchart showing a flow of the commodity registration processing in the self-checkout terminal according to this embodiment. In this embodiment, if it is determined that the commodity represented by the input commodity information is not the same as that which was already registered in the same transaction processing (No: Act 704), the registration unit 603 stores the input commodity information on the RAM 254 regardless of the weight scaling result of the commodity by the weighing apparatus 301 and registers the commodity (Act 1001).

In addition, even if the number is input after the multiplication button 210b is pressed within the predetermined time period after the input of the commodity information (Act 706), the registration unit 603 stores on the RAM 254 the input commodity information corresponding to the input number of the commodities regardless of the weight scaling result of the commodities by the weighing apparatus 301 and registers the commodities (Act 1001).

Moreover, even if the number is input after the message which prompts the input of the number of the commodities is displayed (Act 706), the registration unit 603 stores on the RAM 254 the input commodity information corresponding to the number obtained by adding one to the input number of the commodities and registers the commodities (Act 1001).

As described above, according to the self-checkout terminal 101 of this embodiment, it is possible to shorten the time period required for the commodity registration since it is not necessary to calculate the weight of the input number of the commodities and compare the calculated weight and the weight measurement result of the commodities by the weighing apparatus 301, by registering the input number of the commodities represented by the input commodity information regardless of the weight scaling result of the commodities by the weighing apparatus 301.

In this embodiment, the input number of the commodities represented by the input commodity information may be registered if the weight is measured by the weighing apparatus 301. Hereinafter, the same configurations as those in the aforementioned embodiment will be omitted, and only different configurations from those in the aforementioned embodiment will be described.

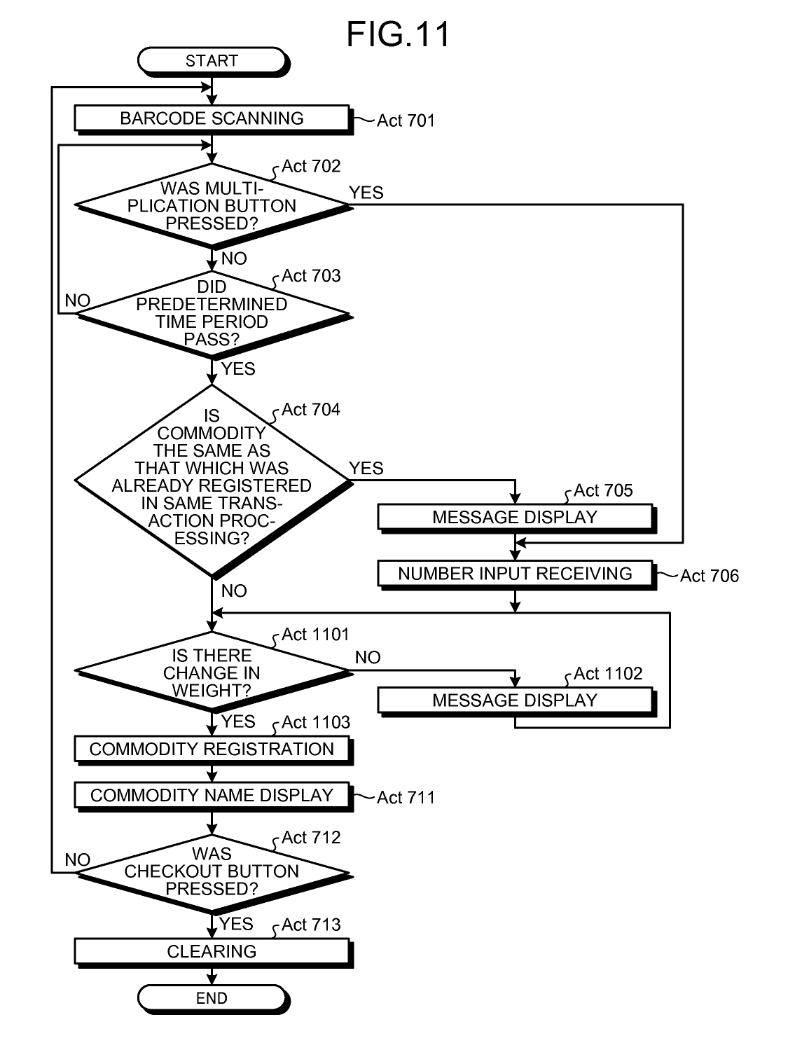

FIG. 11 is a flowchart showing a flow of the commodity registration processing in the self-checkout terminal according to this embodiment. In this embodiment, if it is determined that the commodity represented by the input commodity information is not the same as the commodity which was already registered in the same transaction processing (No: Act 704), the registration unit 603 determines whether or not there is a change in the weight measured by the weighing apparatus 301, that is, whether or not the weight of the commodity was measured by the weighing apparatus 301 (Act 1101). Then, if it is determined that there is no change in the weight measured by the weighing apparatus 301 (No: Act 1101), the notification unit 602 displays on the LCD 210 a message which prompts the scaling of the commodity (Act 1102). On the other hand, if there is a change in the weight measured by the weighing apparatus 301 (Yes: Act 1101), the registration unit 603 stores the input commodity information on the RAM 254 and registers the commodity (Act 1103).

In addition, even if the number is input after the multiplication button 210b is pressed within the predetermined time period after the input of the commodity information (Act 706), the registration unit 603 determines whether or not there is a change in the weight measured by the weighing apparatus 301, that is, whether or not the weight of the commodity was measured by the weighing apparatus 301 (Act 1101). Then, if it is determined that there is no change in the weight measured by the weighing apparatus 301 (No: Act 1101), the notification unit 602 displays on the LCD 210 a message which prompts the scaling of the commodity (Act 1102). On the other hand, if there is a change in the weight measured by the weighing apparatus 301 (Yes: Act 1101), the registration unit 603 stores the input commodity information corresponding to the input number on the RAM 254 and registers the commodities (Act 1103).

Moreover, even if the number is input after the message which prompts the input of the number of the commodities is displayed (Act 706), the registration unit 603 determines whether or not there is a change in the weight measured by the weighing apparatus 301, that is, whether or not the weighing apparatus 301 measured the weight of the commodities (Act 1101). Then, if it is determined that there is no change in the weight measured by the weighing apparatus 301 (No: Act 1101), the notification unit 602 displays on the LCD 210 a message which prompts the scaling of the commodity (Act 1102). On the other hand, if there is a change in the weight measured by the weighing apparatus 301 (Yes: Act 1101), the registration unit 603 stores on the RAM 254 the input commodity information corresponding to the number obtained by adding one to the input number and registers the commodities (Act 1103).

As described above, according to the self-checkout terminal 101 of this embodiment, it is possible to shorten the time period required for the commodity registration since it is not necessary to calculate the weight of the input number of the commodities and compare the calculated weight and the weight measurement result of the commodities by the weighing apparatus 301, by registering the input number of the commodities represented by the input commodity information if the weight is measured by the weighing apparatus 301.

In this embodiment, the weight of the commodity whose commodity information is input and the weight of the input number of the commodities are separately measured. Hereinafter, the same configurations as those in the aforementioned embodiment will be omitted, and only different configurations from those in the aforementioned embodiment will be described.

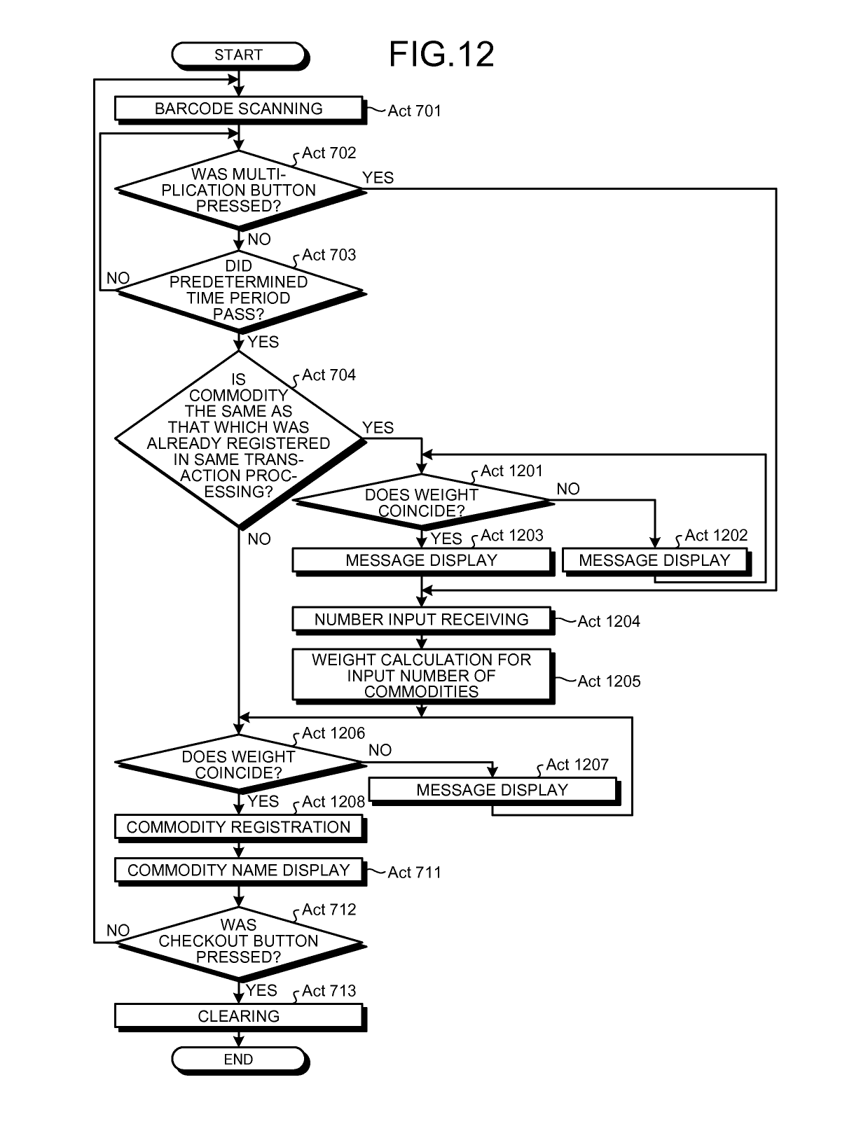

FIG. 12 is a flowchart showing a flow of the commodity registration processing in the self-checkout terminal according to this embodiment. In this embodiment, if it is determined that the commodity represented by the input commodity information is the same as the commodity which was already registered in the same transaction processing (Yes: Act 704), the registration unit 603 reads the weight associated with the commodity code input as the commodity information from the commodity master file T. Then, the registration unit 603 determines whether or not the read weight coincides with the weight of the commodity measured by the weighing apparatus 301 (Act 1201). Here, if the read weight does not coincide with the weight of the commodity measured by the weighing apparatus 301 (No: Act 1201), the notification unit 602 displays on the LCD 210 a message which prompts the rescaling of the commodity (Act 1202).

On the other hand, if the read weight coincides with the weight measured by the weighing apparatus 301 (Yes: Act 1201), the notification unit 602 displays on the LCD 210 a message which prompts the input of the number of the commodities represented by the input commodity information (Act 1203). Even in this embodiment, the notification unit 602 displays a message which prompts the input of the number (remaining number) of the same commodities except for the commodity which was already read by the barcode scanner 203.

After the message which prompts the input of the number of the commodities is displayed on the LCD 210 (Act 1203), the input receiving unit 601 receives the input of the number of the same commodities except for the commodity whose commodity information was input from the barcode scanner 203 (Act 1204). Subsequently, the registration unit 603 reads the weight associated with the commodity code represented by the input commodity information from the commodity master file T. Moreover, the registration unit 603 calculates the weight of the input number of the commodities by multiplying the read weight by the input number (Act 1205).

Then, the registration unit 603 determines whether or not the calculated weight coincides with the weight of the commodities measured by the weighing apparatus 301 (Act 1206). If the calculated commodity weight does not coincide with the weight of the commodities measured by the weighing apparatus 301 (No: Act 1206), the notification unit 602 displays on the LCD 210 a message which prompts the customer to place the commodities again on the weighting dish 303 (Act 1207).

On the other hand, if the calculated commodity weight coincides with the weight of the commodity measured by the weighing apparatus 301 (Yes: Act 1206), the registration unit 603 stores the input commodity information corresponding to the number obtained by adding one to the input number on the RAM 254 and registers the commodities (Act 1208).

As described above, according to the self-checkout terminal 101 of this embodiment, the commodities as the targets of the weight scaling can easily be distinguished by separately scaling the weight of the commodity whose commodity information was input and the weight of the input number of the commodities.

In addition, a program executed by the self-checkout terminal 101 of this embodiment can be provided by being assembled in advance in a ROM or the like.

Moreover, the program executed by the self-checkout terminal 101 of this embodiment may be provided by being recorded as a file in an installable or executable format in a computer-readable recording medium such as a CD-ROM, a flexible disc (FD), a CD-R, a DVD (Digital Versatile Disc), or the like.

Furthermore, the program executed by the self-checkout terminal 101 of this embodiment may be stored in a computer connected to the network such as the Internet, and provided by being downloaded via the network. In addition, the program executed by the self-checkout terminal 101 of this embodiment may be provided or distributed via the network such as the Internet.

Further effects and modified examples can easily be achieved by those skilled in the art. Accordingly, the wide scope of the exemplary embodiments is not limited to specific details and representative embodiments shown and described as above. Therefore, various modifications can be made without departing from the overall spirit and scope of the exemplary embodiments defined by the accompanying claims and equivalents thereof.

What is claimed is:

1. An information processing apparatus comprising:
an input unit which inputs commodity information representing a commodity to be registered;
a notification unit which notifies of the fact that it is possible to input the number of commodities, which are represented by the input commodity information, to be registered in same transaction processing if the commodity represented by the input commodity information is the same as a commodity which was already registered in the same transaction processing;
a receiving unit which receives the input of the number of commodities, which are represented by the input commodity information, to be registered in the same transaction processing; and
a registration unit which registers the input number of commodities represented by the input commodity information.

2. The apparatus according to claim 1, further comprising:
a scaling unit which measures the weight of the commodity represented by the input commodity information,
wherein the registration unit registers the input number of commodities represented by the input commodity information if the weight is measured by the scaling unit.

3. The apparatus according to claim 2,
wherein the scaling unit measures the weight of the input number of commodities represented by the input commodity information, and
wherein the registration unit registers the input number of commodities represented by the input commodity information if the measured weight coincides with the weight obtained by multiplying preset weight of the commodity represented by the input commodity information by the input number.

4. The apparatus according to claim 1,
wherein the notification unit notifies of the fact that it is possible to input the number of commodities, which are represented by the input commodity information, to be registered in the same transaction processing by displaying a message on a display unit.

5. The apparatus according to claim 1,
wherein the notification unit notifies of the fact that it is possible to input the number of commodities, which are represented by the input commodity information, to be registered in the same transaction processing if the number of commodities, which are represented by the commodity information, to be registered in the same transaction processing is not input within a predetermined time period after the input of the commodity information and the commodity represented by the input commodity information is the same as a commodity which was already registered in the same transaction processing.

6. A computer program product including a computer-readable recording medium which includes a plurality of computer-executable orders for commodity registration, the plurality of orders comprising:
notifying of the fact that it is possible to input the number of commodities, which are represented by the input commodity information, to be registered in same transaction processing if the commodity represented by externally input commodity information is the same as a commodity which was already registered in the same transaction processing;
receiving the input of the number of commodities, which are represented by the input commodity information, to be registered in the same transaction processing; and
registering the input number of commodities represented by the input commodity information.

7. The computer program product according to claim 6,
wherein the input number of commodities represented by the input commodity information are registered if the weight is measured by the scaling unit which measures the weight of commodities represented by the input commodity information.

8. The computer program product according to claim 7,
wherein the input number of commodities represented by the input commodity information are registered if the measured weight coincides with the weight obtained by multiplying preset weight of the commodity represented by the input commodity information by the input number.

9. The computer program product according to claim 6,
wherein the fact that it is possible to input the number of commodities, which are represented by the input commodity information, to be registered in the same transaction processing is notified by displaying a message on a display unit.

10. The computer program product according to claim 6,
wherein the fact that it is possible to input the number of commodities, which are represented by the input commodity information, to be registered in the same transaction processing is notified if the number of commodities, which are represented by the commodity information, to be registered in the same transaction processing is not input within a predetermined time period after the input of the commodity information and the commodity represented by the input commodity information is the same as a commodity which was already registered in the same transaction processing.
